(19) United States
(12) Patent Application Publication
(10) Pub. No.: US 2004/0228562 A1
(43) Pub. Date: Nov. 18, 2004

(54) Caged roller assembly

(75) Inventors: Shinji Oishi, Iwata-shi (JP); Ayumu Yamamoto, Iwata-shi (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 10/873,109

(22) Filed: Jun. 23, 2004

(30) Foreign Application Priority Data
Mar. 7, 2003 (JP) 2003-190916

(51) Int. Cl. F16C 33/46; B62D 53/08

(52) U.S. Cl. 384/580

(57) ABSTRACT

The caged roller assembly includes a roller cage and a plurality of rollers. The roller cage has annular end walls axially spaced from and axially opposed to each other, and a plurality of elongated pillars spaced from each other in a direction circumferentially of the roller cage and extending perpendicularly between respective outer peripheral edges of the annular end walls. The rollers are rollingly accommodated within respective pockets, each defined between the neighboring pillars. An annular inner portion of one or both of the annular end walls, which is situated between the neighboring rollers, is formed with a roller restraint pawl in the form of a bent piece, which operates to prevent the respective roller from being separated radially inwardly away from the roller cage. The roller cage is, prior to the rollers being mounted in the associated pockets, heat treated, and the roller restraint pawls is annealed or anti-carburized to a hardness equal to or lower than the hardness of the roller cage and not higher than Hv 400.

### BACKGROUND OF THE INVENTION

1. Field of the Invention

The present invention generally relates to a caged roller assembly that is generally utilized in industrial machinery, with a high load bearing capacity.

2. Description of the Prior Art

The caged roller assembly of a type utilizing cylindrical rollers and a cage rotatably retaining the rollers, which is compact in size and capable of exhibiting a high load bearing capability is well known in the art and is currently available in various designs such as disclosed in, for example, the Japanese Laid-open Patent Publication No. 2000-179544 and the Japanese Laid-open Patent Publication No. 2003-166540.

In general, in order to increase the load bearing capability of a rolling bearing, there has been no way other than to increase the size of the roller bearing or to design it to be a full type roller bearing with no cage. However, it has been found that an increase of the roller bearing requires a concomitant change in design of the shaft and/or housing. It has also been found that designing the full type roller bearing tends to bring about problems associated with roller skew and/or roller seizure.

In order to alleviate those problems, the above mentioned patent publication No. 2000-179544 has suggested to tailor the shape of the roller cage in such a way as to enable a number of rollers to be accommodated in a limited available space so that the load bearing capability can be increased drastically while the roller bearing remains the same in size as that hitherto utilized. This will be discussed in detail with particular reference to FIGS. 10A and 10B showing in perspective and transverse sectional views, respectively, only a portion of the caged roller assembly suggested in the above mentioned patent publication No. 2000-179544.

Referring to FIGS. 10A and 10B, the prior art caged roller assembly includes a roller cage 40 of a generally annular configuration having a transverse sectional representation similar to the shape of a figure “M” and a plurality of rollers 44 rotatably retained by the roller cage 40. Specifically, the roller cage 40 includes an intermediate annular base wall 41 of a diameter smaller than the pitch circle diameter PCD, i.e., the diameter of the pitch circle depicted so as to pass through respective longitudinal axes of the rollers 44 then arranged in a circumferentially extending row, a pair of outer annular wings 42 of a diameter greater than the pitch circle diameter PCD and continued from opposite side edges of and positioned on respective sides of the intermediate annular base wall 41, and a collar 43 bent from an outer side edge of each of the outer annular wings 42 so as to extend radially inwardly from the associated outer annular wing 42. A plurality of roller retaining pockets 45 of a generally rectangular configuration and equal in number to the number of the rollers 44 employed are defined in the roller cage 40, particularly in part in the intermediate annular base wall 41 and in part in the outer annular wings 42, and are spaced an equal distance from each other in a direction circumferentially of the roller cage 40.

In this prior art caged roller assembly, the roller cage 40 is so designed that separation of one or some of the rollers 44 in directions outwardly and inwardly of the roller cage 40 is accomplished by the outer annular wings 42 and the intermediate annular base wall 41, respectively. In other words, the roller cage 40 has restraint tongues 46 protruding into each of the roller retaining pockets 45 from opposite side edges, defining each of the pockets 45, in a direction close towards each other, so as to leave therebetween a space of a size (width) slightly smaller than the outer diameter of the corresponding roller 44. Mounting each of the rollers 44 into the associated pocket 45 is carried out radially outwardly from the roller cage 40 by allowing two of the restraint tongues 46, that are integral with the intermediate annular base wall 41, to be elastically deformed to allow passage of the respective roller 44 therebetween. At this time, the remaining restraint tongues 46, that are integral with the outer annular wings 42 on respective sides of the restraint tongues 46 integral with the intermediate annular base wall 41, serve to avoid separation of the respective roller 44 in a direction radially outwardly of the associated pocket 45.

The caged roller assembly disclosed in the above mentioned patent publication No. 2003-166540 and reproduced in FIGS. 11 to 13 hereof includes a roller cage 51 made up of an outer annular member 53 and an inner annular member 54, and a plurality of rollers 52. The outer annular member 53 is made up of an annular base wall 53a of a diameter greater than the pitch circle PCD diameter depicted in the circular row of the rollers 52, and an annular collar 53b bent from an outer side edge of each of the annular base wall 53a so as to extend radially inwardly from the annular base wall 53a. On the other hand, the inner annular member 54 is of a diameter smaller than the pitch circle diameter PCD. The annular base wall 53a of the outer annular member 53 has a circumferential row of pockets 55 defined therein in equidistantly spaced relation to each other in a direction circumferentially thereof and, similarly, the inner annular members 53 and 54 have respective circumferential rows of pockets 56 defined therein in equidistantly spaced relation to each other in a direction circumferentially thereof and radially aligned with the pockets 55 in the annular base wall 53a, with the rollers 52 rotatably accommodated in part within the pockets 55 and in part within the pockets 56. Formation of the pockets 56 in each of the outer and inner annular members 53 and 54 leaves pillars 57 or 58 each positioned on opposite sides of the corresponding pocket 56 with respect to the circumferential direction of the respective annular member 53 or 54, each pillar 57 or 58 having a width as measured in the circumferential direction thereof.

Where the roller cage 51 is of two-piece construction made up of the outer and inner annular members 53 and 54 such as discussed above, the pillars 57 and 58 in the outer and inner annular members 53 and 54 can be formed to have a relatively small width within the space available in those annular members 53 and 54, allowing a large number of the pockets 56 defined therein so that as many rollers 52 as possible can advantageously be accommodated. Also, since only one of the outer and inner annular members, specifically the outer annular member 53 is formed with the collars 53a and 53b, no interference with adjacent component parts will occur in any way.

However, the caged roller assembly of the known structure shown in FIGS. 10A and 10B, has been found having a problem in that the number of the rollers 44 to be mounted in the roller cage 40 is increased, each of the pillars between the neighboring pockets 45 in the roller cage 40 will have a less width a, as measured in a direction circumferentially of the roller cage 40, resulting in limitations imposed on machining and reduction in strength of the caged roller assembly.

In the case of the caged roller assembly of the structure shown in FIGS. 11 to 13, the two components, i.e., the outer and inner annular members 53 and 54 are employed to form the caged roller assembly to prevent the rollers 52 from being undesirably separated or falling off from the assembly and, therefore, the number of component parts forming the assembly is relatively large, accompanied by increase in manufacturing cost. Also, since the capacity of the space available in the bearing of a type utilizing the caged roller assembly is relatively small in the presence of the inner annular member 54, it may be anticipated that the use of the caged roller assembly of the structure shown in FIGS. 11 to 13 would pose a disadvantage in flow of a lubricant oil in the bearing.

In order to alleviate those disadvantages and inconveniences, the assignee of the present invention has suggested the caged roller assembly of the structure shown in FIGS. 14 to 16, which is the subject of the invention applied for patent in their Japanese Laid-open Patent Publication No. 2004-019923.

Referring now to FIGS. 14 to 16, the caged roller assembly shown therein includes an annular cage 61 and a plurality of rollers 62 rotatably carried by the annular cage 61. The annular cage 62 is made up of a pair of axially spaced annular end walls 63 and a plurality of elongated pillars 65 spaced equidistantly in a direction circumferentially of the annular cage 62 and bridging between respective outer peripheries of the annular end walls 63 to render the annular cage 62 to have a generally U-sectioned configuration opening radially inwardly thereof. The neighboring pillars 65 define a pocket 66 therebetween to accommodate the corresponding roller 62.

One or both of the annular end walls 63 have a restraint means 67 defined in an annular inner surface thereof at a location between the neighboring rollers 62, then received in the corresponding pockets 65, for restraining the corresponding roller 62 from being separated in a direction radially inwardly of the annular cage 62. The respective restraint means 67 referred to above is in the form of, for example, a staked protuberance extending axially inwardly from the end wall or walls 63.

As compared with the caged roller assembly of the structure shown in FIGS. 11 to 13, the caged roller assembly shown in FIGS. 14 to 16 is particularly advantageous in that the flow of the lubricant oil can be desirably improved and the number of component parts used can be reduced. However, with this structure, it has been found extremely difficult to position an anvil or similar backing element adjacent the annular inner surface of the annular end walls 63 at the time of formation of the corresponding restraint means 67 by the use of any known staking technique. Because of this, it may be expected that problems associated with manufacture and quality would be encountered, such as, for example, the resultant staked protuberances failing to satisfy the specific dimensional requirements.

In view of the foregoing, the assignee of the present invention has tried to use, in place of the restraint means 67 in the form of the staked protuberances, roller retaining pawls each in the form of a bent piece. The roller retaining pawls in the form of the bent piece has been used in a bearing of a type quite different from the caged roller assembly, that is, the cylindrical roller bearing of a structure including inner and outer race with the outer race formed with collars as disclosed in, for example, the Japanese Laid-open Utility Model Publication No. 55-49148 referred to hereinbefore.

However, when it comes to the application to the caged roller assembly of a type which does not make use of the inner and outer races and which is utilized with the rollers rollingly held in contact with the shaft and the housing, the roller cage including the roller retaining pawls has to be subjected to a hardening treatment in order to cope with the contact between the roller cage and the adjacent component parts. It has accordingly been found that some or all of the roller retaining pawls after the hardening treatment are liable to break when bent, after the rollers have been inserted into the corresponding pockets in the roller cage, to retain the rollers in position within the pockets.

### SUMMARY OF THE INVENTION

In view of the foregoing, the present invention is intended to provide a caged roller assembly of a kind which has a high load bearing capability within a limited space, is easy to machine, allows an easy passage of a lubricant oil therethrough, and is substantially free from breakage of roller retaining pawls, which would otherwise occur when the roller retaining pawls are bent.

In order to accomplish the foregoing object of the present invention, the caged roller assembly herein disclosed includes a roller cage having annular end walls axially spaced from and axially opposed to each other, and a plurality of elongated pillars spaced from each other in a direction circumferentially of the roller cage and extending perpendicularly between respective outer peripheral edges of the annular end walls, with a pocket defined between the neighboring pillars. Rollers are rollingly accommodated within the respective pockets in a fashion spaced a distance from each other in a direction circumferentially of the roller cage and restrained in position from being separated radially outwardly away from the roller cage both by means of the pillars.

An annular inner portion of each of the annular end walls, which is situated between the neighboring rollers, is formed with a roller restraint pawl in the form of a bent piece, which operates to prevent the respective roller from being separated radially inwardly away from the roller cage. This caged roller assembly is operatively used with the rollers held in rolling contact in part with a shaft element and in part with a housing enclosing the shaft element.

The roller cage employed in the caged roller assembly of the present invention is, prior to the rollers being mounted in the associated pockets, heat treated. The roller restraint pawls in each of the annular end walls have a hardness equal to or lower than the hardness of the roller cage in its entirety and is annealed or anti-carburized (i.e., protected from being carburized) to a hardness of not higher than Hv 400.

According to the present invention, the pillars and the roller restraint pawls both provided in the roller cage take respective roles of preventing the rollers from separating radially outwardly and inwardly and, therefore, the pillars can have an advantageously simplified shape and, also, the pillars can be positioned at a location further radially outwardly with the spacing between the neighboring rollers minimized. As such, the number of the rollers that can be employed within a limited space can advantageously be increased, allowing the caged roller assembly to have a high load bearing capability.

Also, since possible separation of the rollers in a direction radially inwardly of the caged roller assembly is prevented by the roller restraint pawls formed in at least one of the annular end walls of the roller cage, the roller cage can be manufactured of one-piece construction and, hence, the number of component parts can advantageously be reduced, resulting in reduction in manufacturing cost. In addition, since the roller restraint pawls are formed in at least one of the annular end walls of the roller cage, they can be formed as a small portion thereof that lies in an axial direction of the roller cage unlike the pillars. Because of this, the space capacity within the bearing will be little reduced and, as compared with the case in which the pillars are provided at radially inward portion of the roller cage, the flow of a lubricant oil can advantageously be improved.

Considering that the roller cage is heat treated prior to the rollers being assembled therein, the heat treatment can be advantageously carried out under a heating condition appropriate or optimal to the roller cage independently of the rollers. However, there would be a problem in that since in order for the rollers to be retained in position by the roller cage the roller restraint pawls must be bent after the heat treatment, they may be likely to be damaged during the bending process. According to the present invention, however, the bending of the roller restraint pawls can easily and successfully be performed with no possibility of the roller restraint pawls being damaged or otherwise cracked, since the roller restraint pawls are annealed or anti-carburized to a hardness equal to or lower than the hardness of the roller cage and also to a hardness of not higher than Hv 400. In addition, since the roller restraint pawls can be formed by the use of any known bending technique, the formation thereof can easily be accomplished as compared with those formed by the use of a staking technique.

In the practice of the present invention, each of the roller restraint pawls may be bent at an angle within the range of 30 to 90° relative to the adjacent annular end wall. The bending angle within the range of 30 to 90° is effective to allow the rollers to be retained in position within the pockets without the rollers being separated from the roller cage and also without problem associated with breakage of the roller restraint pawls.

Also, in the practice of the present invention, each of the roller restraint pawls may have a length sufficient to allow it to engage a chamfered portion of the respective roller. In other words, each of the roller restraint pawls may be of a length sufficient to allow the roller restraint pawl to assuredly engage the chamfered portion of the respective roller, but not to protrude beyond the chamfered portion of the roller excessively. Selection of such a length for each of the roller restraint pawls is effective to prevent the rollers from separating in a direction radially inwardly of the roller cage and, at the same time to increase the space for accommodating the rollers.

Each of the roller restraint pawls may be bent to represent an arcuate or curved shape or to represent a straight shape. Where the roller restraint pawl represents an arcuate shape, the respective roller can have a large play in a direction axially thereof.

Also, each of the roller restraint pawls may have its thickness progressively decreasing towards the tip thereof. In other words, each pawl may be tapered. This feature is particularly advantageous in that an undesirable interference between the roller restraint pawls and a shaft can little occur while the spacing between the neighboring rollers can be reduced with the roller restraint pawls positioned radially inwardly at most.

The roller restraint pawls may be formed in only one or both of the annular end walls of the roller cage. Where the roller restraint pawls are formed in only one of the annular end walls, the roller cage can be easily manufactured with the reduction of manufacturing cost. In this case, it may occur that while each of the rollers can be supported at one end by the associated roller restraint pawl, the other end of the respective roller adjacent the annular end wall where no roller restraint pawl is formed may displace or incline radially inwardly of the roller cage. However, proper selection of the relationship of the spacing between the opposite annular end walls with the length of the roller allows such other end of each roller to be held in contact with an annular inner surface of the annular end wall without allowing such roller to separate therefrom.

It is to be noted that the roller restraint pawls are utilized to allow the roller cage to hold the rollers in position, only when the caged roller assembly by itself is handled prior to being mounted in a planetary reduction gear device or any machinery in which it is desired to be mounted. The roller restraint pawls are no longer needed to perform their function after the resultant caged roller assembly is mounted in the planetary reduction gear device or any other machinery. Accordingly, even though the rollers held by the roller cage are inclined on the account that they are retained in position only at one end by the respective roller restraint pawls formed in only one of the annular end walls, the performance of the caged roller assembly mounted in the planetary reduction gear device or any machinery will not be adversely affected.

In a preferred embodiment of the present invention, the caged roller assembly of the present invention may be disposed between a crankshaft and at least one planetary gear mounted on the crankshaft, said crankshaft and said at least one planetary gear forming respective parts of a planetary reduction gear device. When the caged roller assembly constructed in accordance with the present invention is used in the planetary reduction gear device, the problem associated with interference between an inner peripheral surface of a planetary gear and the caged roller assembly, which would occur when the caged roller assembly is held in sliding contact with adjoining eccentric planetary gear, can be advantageously eliminated because of the presence of the collar-like annular end walls on respective sides of the roller cage.

The present invention also provides a caged roller assembly, which includes a roller cage having annular end walls axially spaced from and axially opposed to each other, and a plurality of elongated pillars spaced from each other in a direction circumferentially of the roller cage and extending perpendicularly between respective outer peripheral edges of the annular end walls, with a pocket defined between the neighboring pillars. Rollers are rollingly accommodated within the respective pockets in a fashion spaced a distance from each other in a direction circumferentially of the roller cage and restrained in position from being separated radially outwardly away from the roller cage by means of the pillars. A roller restraint pawl in the form of a bent piece is formed at a portion of an annular inner portion of at least one of the annular end walls, which is situated between the neighboring rollers, for preventing the respective roller from being separated radially inwardly away from the roller cage, wherein the caged roller assembly is operatively used with the rollers held in rolling contact in part with a shaft element and in part with a housing enclosing the shaft element and wherein the roller cage and the rollers are, after the rollers have been mounted in the associated pockets, heat treated.

In the case of this structure, the cost of the heat treatment can advantageously be reduced since the rollers and the roller cage are heat treated together, and the breakage of the roller restraint pawls can be avoided if they are machined prior to the heat treatment.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a transverse sectional view of a caged roller assembly according to a first preferred embodiment of the present invention;

FIG. 2 is a cross-sectional view of the caged roller assembly taken along the line II-II in FIG. 1;

FIG. 3 is a front elevational view of the caged roller assembly shown in FIG. 1;

FIG. 4 is a cross-sectional view, on an enlarged scale of a portion of the caged roller assembly shown in FIG. 1, showing the details of roller restrains pawls formed therein;

FIG. 5 is a fragmentary enlarged view similar to FIG. 4, showing a modified form of the roller restraint pawls in the caged roller assembly;

FIG. 6 is a fragmentary enlarged view similar to FIG. 4, showing a further modified form of the roller restraint pawls in the caged roller assembly;

FIG. 7 is a fragmentary sectional view, on an enlarged scale, showing a portion of a caged roller assembly having roller restraint pawls according to a second preferred embodiment of the present invention;

FIG. 8 is a schematic diagram showing a planetary gear reduction device utilizing the caged roller assemblies of the present invention;

FIG. 9 is a side view, with a portion cut out, showing the use of the caged roller assemblies incorporated in the planetary gear reduction device shown in FIG. 8;

FIG. 10A is a fragmentary perspective view of the prior art caged roller assembly, showing the details of the roller cage;

FIG. 10B is a fragmentary sectional view of the prior art caged roller assembly shown in FIG. 1A;

FIG. 11 is a transverse sectional view of the other conventional caged roller assembly;

FIG. 12 is a cross-sectional view taken along the line XII-XII in FIG. 11;

FIG. 13 is a front elevational view of the conventional caged roller assembly shown in FIG. 11;

FIG. 14 is a transverse sectional view of the caged roller assembly suggested by the assignee of the present invention;

FIG. 15 is a cross-sectional view taken along the line XV-XV in FIG. 14;

FIG. 16A is an enlarged view showing a portion of the caged roller assembly of FIG. 14, which is marked by A in FIG. 15; and

FIG. 16B is a fragmentary perspective view of a portion of the caged roller assembly of FIG. 14, showing the details of one of roller restraint pawls employed therein.

### DETAILED DESCRIPTION OF THE EMBODIMENTS

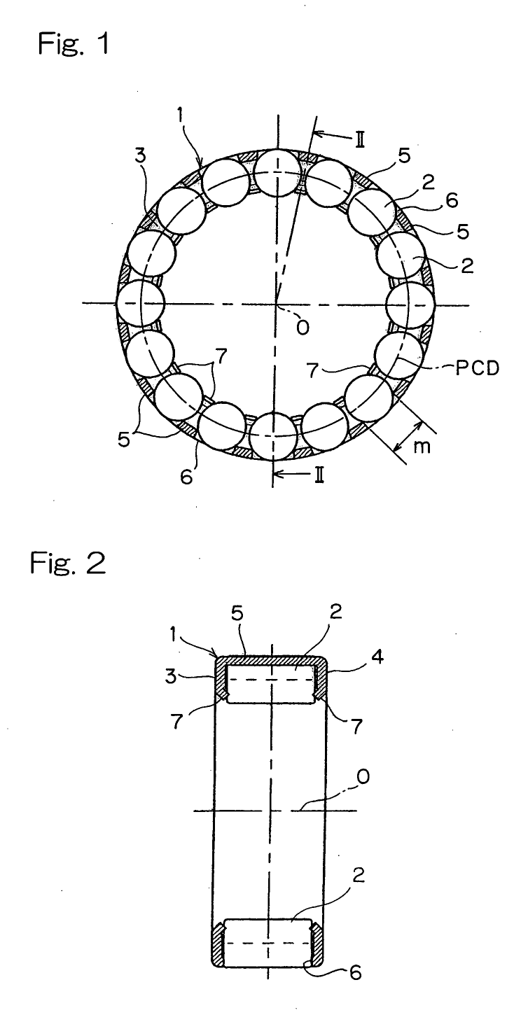

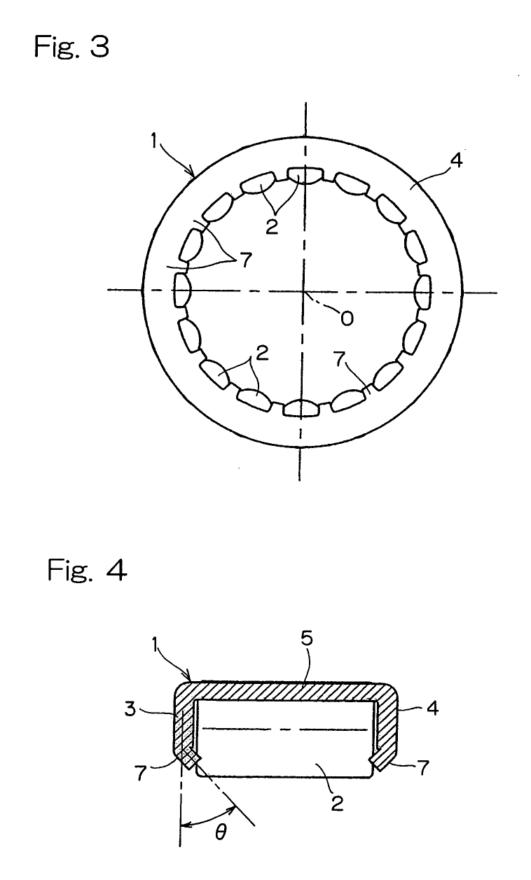

Referring now to FIGS. 1 to 4, a caged roller assembly according to a first preferred embodiment of the present invention will be described. As shown therein, the caged roller assembly includes an annular roller cage 1 and a circumferentially extending row of rollers 2 and is operatively used with the rollers 2 held in rolling contact in part with an outer peripheral surface of a shaft element (not shown) and in part with an inner peripheral surface of a housing (not shown) enclosing the shaft element to allow the shaft element to rotate smoothly relative to the housing.

The roller cage 1 includes annular end walls 3 and 4 axially spaced from and axially opposed to each other, and a plurality of generally rectangular pillars 5 spaced from each other in a direction circumferentially of the roller cage 1 and extending perpendicularly between respective outer peripheral edges of the annular end walls 3 and 4, with a pocket 6 defined between the neighboring pillars 5. The rollers 2 are rollingly accommodated within the respective pockets 6 and are spaced a distance from each other by the pillars 5 in a direction circumferentially of the roller cage 1.

An annular inner portion of each of the annular end walls 3 and 4, which is situated between the neighboring rollers 2, is formed with a roller restraint pawl 7 in the form of a bent piece, which operates to prevent the respective roller 2 from being separated radially inwardly away from the roller cage 1. The rollers 2 are made of, for example, a bearing steel and is in the form of, for example, a needle roller.

Each of the annular end walls 3 and 4 of the roller cage 1 is in the form of an annular flat plate lying perpendicular to the longitudinal or center axis O of the roller cage 1, representing a so-called collar. Each of the pockets 6 defined between the neighboring pillars 5 has a width m as measured in a direction circumferentially of the roller cage 1, which width m is slightly smaller than an outer diameter of each of the rollers 2 so that the neighboring pillars 5 can in effect prevent the respective roller 2 from being separated radially outwardly of the roller cage 1. The pillars 5 in the roller cage 1 are positioned radially outwardly of the pitch circle diameter PCD of the row of the rollers 2, while the roller restraint pawls 7 in each of the end walls 3 and 4 are positioned radially inwardly of the pitch circle diameter D.

As a matter of design, the roller cage 1 may be prepared from a single steel block by means of any known milling work. The roller cage 1 may also be prepared from a single steel plate by means of any known press work. The roller restraint pawls 7 are formed in each of the end walls 3 and 4 so as to protrude in a radial pattern in a direction radially inwardly of the respective end walls 3 and 4. Formation of the roller restraint pawls 7 may be carried out, for example, by means of a press work, a wire cutting technique or an electric discharge machining technique.

The roller cage 1 so prepared is in its entirety heat treated. For this heat treatment, a case hardening treatment, a nitrocarburizing or soft nitriding treatment or the like can be suitably employed. Specifically, if the roller cage 1 is desired to have a hardness within the range of Hv 400 to Hv 650, the case hardening treatment can be conveniently employed, but if it be desired to have a hardness equal to or higher than Hv 300, the nitrocarburizing treatment can be conveniently employed. If during this heat treatment, the roller restraint pawls 7 are anti-carburized, i.e., treated so as to be protected from being carburized, or annealed subsequent to the hardening, bending of the roller restraint pawls 7 can be easily accomplished when the rollers 2 are to be mounted into the respective pockets 6 as will be described subsequently.

In the condition in which the roller cage 1 has been completely heat treated in the manner described above, the roller restraint pawls 1 have a hardness equal to or lower than that of the roller cage 1 as a whole and not higher than Hv 400. After the rollers 2 have been mounted in the pockets 6 in the roller cage 1 having been so heat treated, the roller restraint pawls 7 have to be bent inwardly of the end walls 3 and 4. This bending may be performed by means of a press work or a spinning technique.

The condition in which the roller restraint pawls 7 have been bent to retain the rollers 2 in position within the respective pockets 6 is shown in FIG. 4 in a fragmentary transverse sectional representation. Each of the roller restraint pawls 7 is bent at an angle θ within the range of 30 to 90° relative to the plane of the adjacent end wall 3 and 4. If the bending angle θ is smaller than the lowermost limit of 30°, there is a risk of the respective roller 2 sneaking through the associated pocket 6 past the roller restraint pawls 7 to finally be separated away from the roller cage 1. On the other hand, if the bending angle θ is larger than the uppermost limit of 90°, there is a high risk of the roller restraint pawls 7 being damaged or broken. Accordingly, the bending angle θ within the range of 30 to 90° is effective to retain the rollers 2 in position within the pockets 6 without the rollers 2 being separated from the roller cage 1 and also without problem associated with breakage of the roller restraint pawls 7.

Preferably, each of the roller restraint pawls 7 has a length sufficient to allow the respective roller restraint pawl 7 to engage a chamfered portion of the associated roller 2. Thus, proper selection of the bending angle θ and the length of each of the roller restraint pawls 7 are effective to assuredly prevent the rollers 2 from being separated or falling radially inwardly of the roller cage 1 without the space for accommodation of the respective roller 2 being adversely reduced.

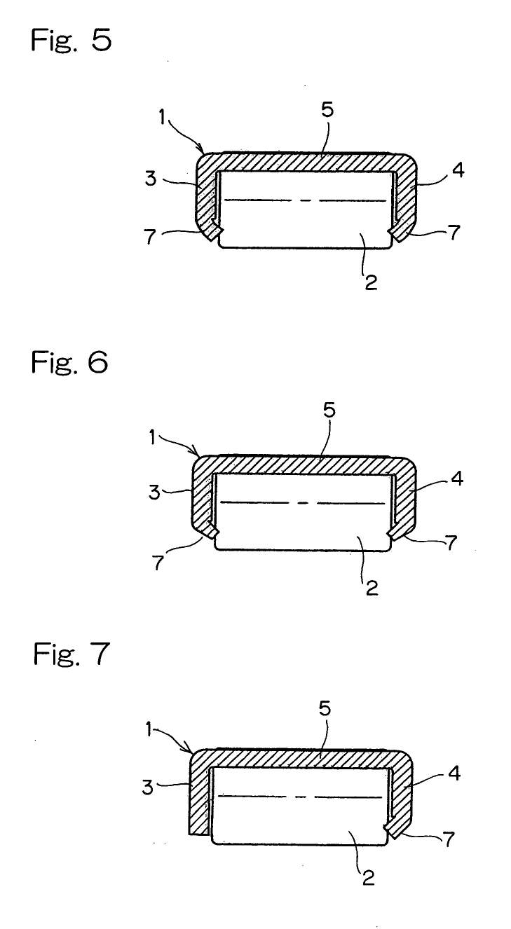

It is to be noted that although in FIG. 4 each of the roller restraint pawls 7 which is bent from the respective annular end walls 3 and 4 is shown as extending straight, each of the roller restraint pawls 7 may be bent to represent an arcuate or curved shape with its inner side formed as an inwardly depressed portion as shown in FIG. 5, or each of the roller restraint pawls 7 may be tapered as shown in FIG. 6 to have a thickness progressively decreasing towards the tip thereof. It is also to be noted that the tapering feature shown in and described with reference to FIG. 6 can be equally applied to each of the roller restraint pawls 7 shown in any one of FIGS. 4 and 5.

With the caged roller assembly so constructed as hereinabove described, the pillars 5 and the roller restraint pawls 7 both provided in the roller cage 1 take respective roles of preventing the rollers 2 from separating radially outwardly and inwardly and, therefore, the pillars 5 can have an advantageously simplified shape and, also, the pillars 5 can be positioned at a location further radially outwardly with the spacing between the neighboring rollers 2 minimized. As such, the number of the rollers 2 that can be employed within a limited space can advantageously be increased, allowing the caged roller assembly to have a high load bearing capability.

Since separation of the rollers 2 in a direction radially inwardly of the caged roller assembly is prevented by the roller restraint pawls 7 formed in the annular end walls 3 and 4 of the roller cage 1, the roller cage 1 can be manufactured of one-piece construction and, hence, the number of component parts can advantageously be reduced, resulting in reduction in manufacturing cost. In addition, since the roller restraint pawls 7 are formed in the annular end walls 3 and 4 of the roller cage 1, they can be formed as a small portion thereof that lies in an axial direction of the roller cage 1 unlike the pillars 5. Because of this, the space capacity within the bearing will be little reduced and, as compared with the case in which the pillars are provided at radially inward portion of the roller cage, the flow of a lubricant oil can advantageously be improved.

Considering that the roller cage 1 is heat treated prior to the rollers 2 being assembled therein, an advantage can be appreciated that the heat treatment, can be carried out under a heating condition appropriate or optimal to the roller cage 1 independently of the rollers 2. However, there would be a problem in that since, in order for the rollers 2 to be retained in position by the roller cage 1, the roller restraint pawls 7 must be bent after the heat treatment, they may be likely to be damaged during the bending process. According to the embodiment discussed hereinabove, however, the bending of the roller restraint pawls 7 can easily and successfully be performed with no possibility of the roller restraint pawls 7 being damaged or otherwise cracked, since the roller restraint pawls 7 are annealed or anti-carburized to a hardness equal to or lower than the hardness of the roller cage 1 and also to a hardness of not higher than Hv 400. In addition, since the roller restraint pawls 7 can be formed by the use of any known bending technique, the formation thereof can easily be accomplished as compared with those formed by the use of a staking technique.

Also, since each of the annular end walls 3 and 4 of the roller cage 1 is in the form of an annular flat plate representing a collar, a surface area can be secured in each of those annular end walls 3 and 4 to a certain extent and, for this reason, even though the caged roller assembly of the present invention is mounted on, for example, a crankshaft for the support of a planetary reduction gear device as will be described later where the roller cage 1 is held in sliding contact with adjacent component parts of the planetary reduction gear device, no interference will occur between the roller cage 1 and inner peripheral surface of those adjacent component parts.

Referring now to FIG. 7 showing another preferred embodiment of the present invention, the caged roller assembly shown therein is similar to that shown in FIGS. 1 to 4, except that the roller restraint pawls 7 are formed only in one of the annular end walls 3 and 4, for example, the annular end wall 4.

Where the roller restraint pawls 7 are formed only in the annular end wall 4 such as in the embodiment shown in FIG. 7, it may occur that while each of the rollers 2 can be supported at one end by the associated roller restraint pawl 7 formed in the end wall 4, the other end of the respective roller 2 adjacent the annular end wall 3 where no pawl is formed may displace or incline radially inwardly of the roller cage 1. However, according to the present invention, the spacing between the annular end walls 3 and 4 is properly selected with respect to the length of each of the rollers 2, allowing such other end of each roller 2 to be held in contact with an annular inner surface of the end wall 3 without such roller 2 being separated therefrom.

Attention is called that only when the caged roller assembly by itself is handled prior to being mounted in the planetary reduction gear device or any machinery in which it is desired to be mounted, the roller restraint pawls 7 are utilized to allow the roller cage 1 to hold the rollers 2 in position while they are no longer needed to perform their function after the resultant caged roller assembly is mounted in the planetary reduction gear device or any other machinery. Accordingly, even though the rollers 2 held by the roller cage 1 are inclined on the account that they are retained in position only at one end by the respective roller restraint pawls 7 formed only in the annular end wall 4, the performance of the caged roller assembly mounted in the planetary reduction gear device or any machinery will not be adversely affected. Thus, allowing the roller 2 to be supported at one end by the roller restraint pawls 7 formed in only the annular end wall 4 is effective to facilitate the manufacturing of the caged roller assembly and, at the same time, to reduce the manufacturing cost.

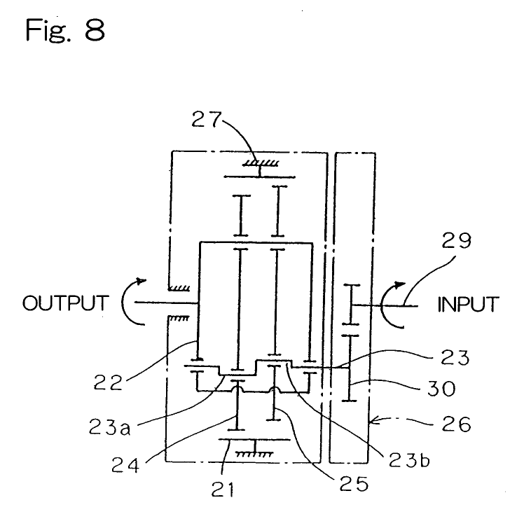

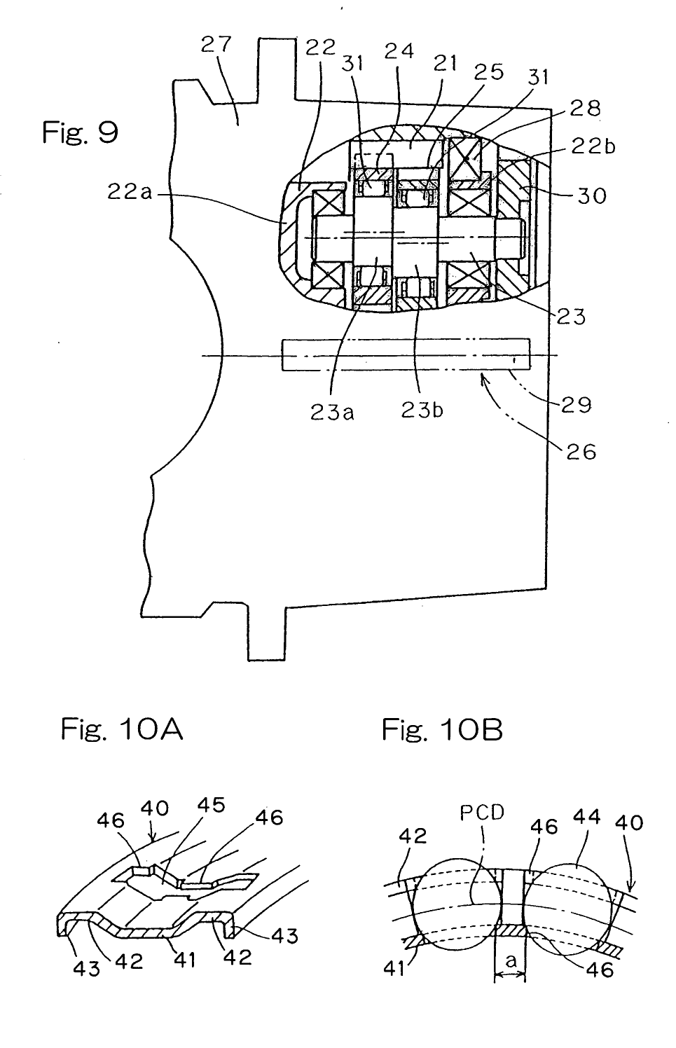

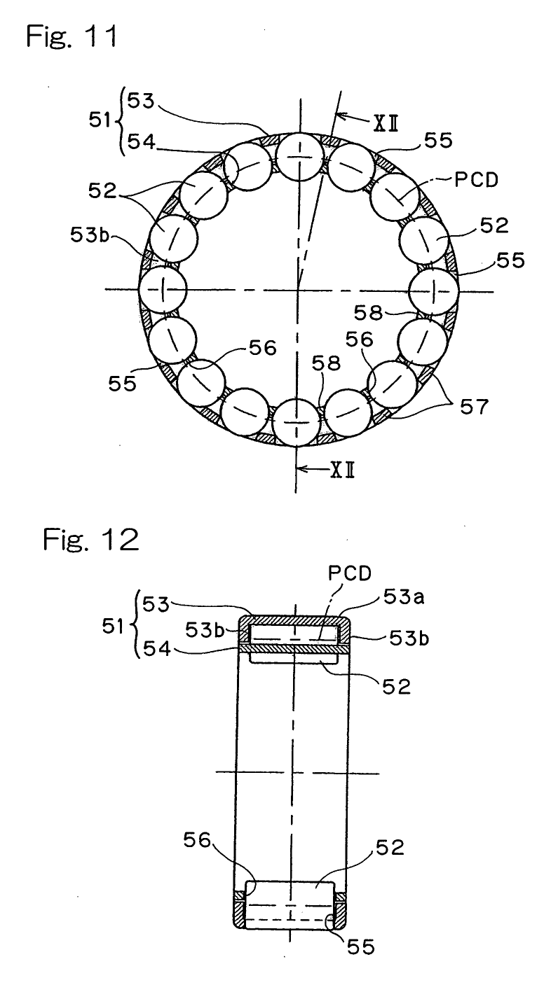

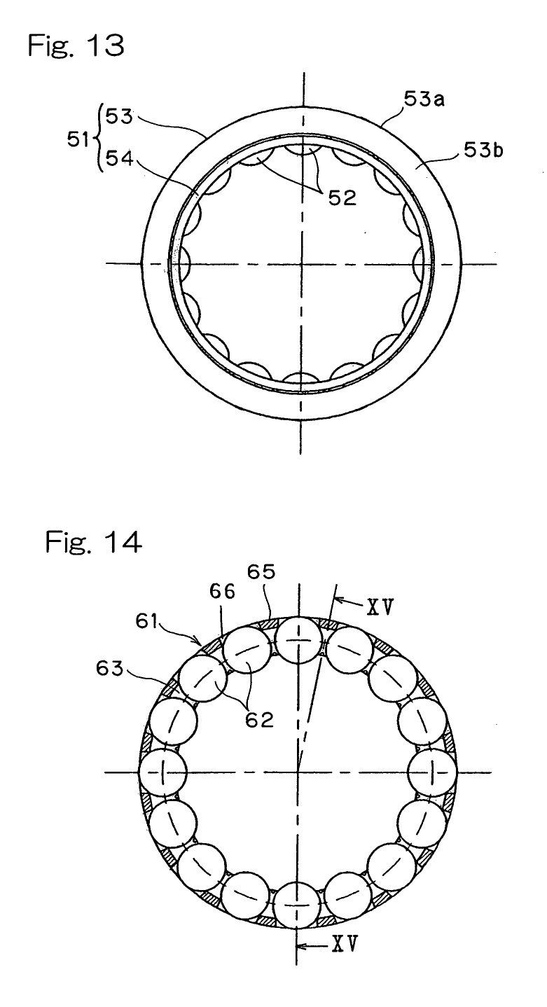

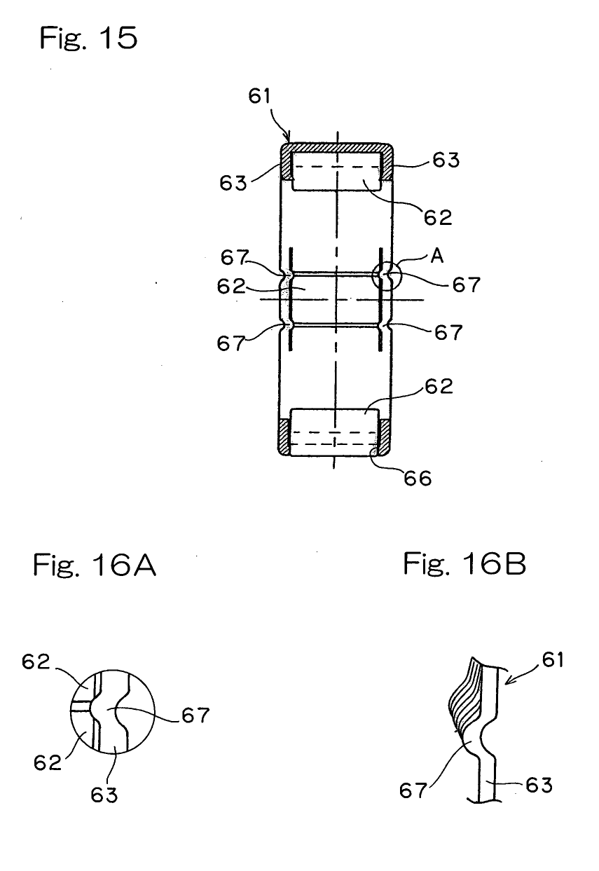

FIGS. 8 and 9 illustrate an example of application of the caged roller assembly of the present invention to the planetary reduction gear device. The planetary reduction gear device includes an internal ring gear 21, carrier 22 providing a rotation output unit, a crankshaft 23 rotatably supported by the carrier 22 and having a plurality of, for example, two, neighboring eccentric shanks 23a and 23b, planetary gears 24 and 25 rotatably mounted on the eccentric shanks 23a and 23b of the crankshaft 23, respectively, and drivingly engageable with the internal ring gear 21, and a rotation input unit 26 for transmitting an external rotatory drive to the crankshaft 23. The internal ring gear 21 is secured to a housing 27 and the carrier 22 is arranged within the housing 27 through a bearing 28 (FIG. 9) for rotation coaxially with the internal ring gear 21.

The rotation input unit 26 includes an input shaft 29 coaxial with the internal ring gear 21 and a drive transmission gear 30 mounted on the crankshaft 23 and drivingly engaged with a toothed portion of the input shaft 29. It is to be noted that the crankshaft 23 are employed in a plural number, for example, three and those three crankshafts 23 are positioned spaced circumferentially of the carrier 22. As best shown in FIG. 9, each of the planetary gears 24 and 25 is rotatably mounted on the associated eccentric shank 23a and 23b through a respective caged roller assembly 31. As a matter of course, this caged roller assembly 31 is that provided for in accordance with the present invention, for 10 example, the caged roller assembly of the structure shown in and described with reference to FIGS. 1 to 4.

The planetary reduction gear device of the structure discussed above operates in the following manner. When the input shaft 29 is driven about its own longitudinal axis, the three crankshafts 23 are driven in unison with each other through the drive transmission gear 30. In this way, one stage of speed reduction is performed. The crankshafts 23 and the planetary gears 24 and 25 are coupled with each other through the respective caged roller assemblies 31 and whirling of the crankshafts 23 is synchronized with rigid motion including revolution of the planetary gears 24 and 25 about the center axis of the ring gear 21 inside the ring gear 21 and rotation of the planetary gears 24 and 25 about their own longitudinal axes.

The axially spaced planetary gears 24 and 25 revolve being meshed with the teeth of the internal ring gear 21 while offset 180° in phase relative to each other. Accordingly, inertia forces brought about by whirling of the two planetary gears 24 and 25 are counterbalanced with each other. While the internal ring gear 21 is fixed to the housing 27, the planetary gears 24 and 25 revolve within and along the internal teeth of the internal ring gear 21. The three crankshafts 23 are each positioned between two discs 22a and 22b of the carrier 22 which serve as an output member. Accordingly, revolution of the planetary gears 24 and 25 is transmitted to the carrier 22 through revolution of the crankshafts 23, with a speed reduced rotation consequently outputted from the carrier 22.

In the planetary reduction gear device of the structure discussed above, a relatively large load acts on each of the caged roller assemblies 31 intervening between the planetary gears 24 and 25 and the eccentric shanks 23a and 23b of the crankshafts 23 and, also, the space for installation of each caged roller assembly 31 is limited to avoid increase of the size of the reduction gear device itself.

In addition, the roller cage of the caged roller assemblies 31 is held in sliding contact with end faces of the adjoining planetary gears 24 and 25. However, the use of the caged roller assemblies of the structure shown in and described in connection with any one of the foregoing embodiments of the present invention is effective to allow a high load bearing capability to be exhibited within the limited space.

Yet, since the roller cage 1 has the collar-like annular end walls 3 and 4 on respective sides thereof, sliding contact thereof with the end faces of the planetary gears 24 and 25 that are neighboring with the respective caged roller assemblies 31 and move eccentrically relative to each other does in no way pose any problem associated with interference with respective inner peripheral surfaces of the planetary gears 24 and 25.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although, in describing the foregoing embodiments of the present invention including the modifications shown respectively in FIGS. 5 to 7, the roller cage 1 itself has been described as heat treated prior to the rollers 2 mounted thereon, the roller cage 1 after the rollers 2 have been mounted thereon with the roller restraint pawls 7 formed to retain the rollers 2, i.e., the complete caged roller assembly may be heat treated. Even though this modification is employed, other structural features are identical to those of the caged roller assembly in the first embodiment described with reference to FIGS. 1 to 4. Also the roller restraint pawls 7 heat treated concurrently with the roller cage 1 may be modified in a manner described with reference to FIGS. 5 to 7.

Where the complete caged roller assembly is heat treated as suggested above, the roller cage 1 and the rollers 2 can be heat treated simultaneously all at a time and, therefore, the cost of the heat treatment can advantageously be reduced and machining of the roller restraint pawls 7 can also be easily performed with no fear of breakage if they are machined prior to the heat treatment.

Accordingly, such changes and modifications are, unless they depart from the scope of the present invention as delivered from the claims annexed hereto, to be construed as included therein.

What is claimed is:

1. A caged roller assembly, which comprises:
a roller cage having annular end walls axially spaced from and axially opposed to each other, and a plurality of elongated pillars spaced from each other in a direction circumferentially of the roller cage and extending perpendicularly between respective outer peripheral edges of the annular end walls, with a pocket defined between the neighboring pillars;
rollers rollingly accommodated within the respective pockets in a fashion spaced a distance from each other in a direction circumferentially of the roller cage and restrained in position from being separated radially outwardly away from the roller cage by means of the pillars; and
a roller restraint pawl in the form of a bent piece formed at an annular inner portion of at least one of the annular end walls, which is situated between the neighboring rollers, for preventing the respective roller from being separated radially inwardly away from the roller cage;
the caged roller assembly being operatively used with the rollers held in rolling contact in part with a shaft element and in part with a housing enclosing the shaft element; and
wherein the roller cage is, prior to the rollers being mounted in the associated pockets, heat treated, and the roller restraint pawls in each of the annular end walls are annealed or anti-carburized to a hardness equal to or lower than that of the roller cage in its entirety and also to a hardness of not higher than Hv 400.

2. The caged roller assembly as claimed in claim 1, wherein each of the roller restraint pawls is bent at an angle within the range of 30 to 90° relative to the adjacent annular end wall.

3. The caged roller assembly as claimed in claim 1, wherein each of the roller restraint pawls has a length sufficient to allow it to engage a chamfered portion of the respective roller.

4. The caged roller assembly as claimed in claim 1, wherein each of the roller restraint pawls is bent to represent a bent piece of an arcuate shape.

5. The caged roller assembly as claimed in claim 1, wherein each of the roller restraint pawls is tapered to have its thickness progressively decreasing towards a tip thereof.

6. The caged roller assembly as claimed in claim 1, wherein the roller restraint pawls are formed in both of the annular end walls.

7. The caged roller assembly as claimed in claim 1, which is disposed between a crankshaft and at least one planetary gear mounted on the crankshaft, said crankshaft and said at least one planetary gear forming respective parts of a planetary reduction gear device.

8. A caged roller assembly, which comprises:
a roller cage having annular end walls axially spaced from and axially opposed to each other, and a plurality of elongated pillars spaced from each other in a direction circumferentially of the roller cage and extending perpendicularly between respective outer peripheral edges of the annular end walls, with a pocket defined between the neighboring pillars;
rollers rollingly accommodated within the respective pockets in a fashion spaced a distance from each other in a direction circumferentially of the roller cage and restrained in position from being separated radially outwardly away from the roller cage by means of the pillars; and
a roller restraint pawl in the form of a bent piece formed at an annular inner portion of at least one of the annular end walls, which is situated between the neighboring rollers, for preventing the respective roller from being separated radially inwardly away from the roller cage;
the caged roller assembly being operatively used with the rollers held in rolling contact in part with a shaft element and in part with a housing enclosing the shaft element; and
Wherein the roller cage and the rollers are, after the rollers have been mounted in the associated pockets, heat treated.
